(19) United States
(12) Patent Application Publication
(10) Pub. No.: US 2015/0007282 A1
(43) Pub. Date: Jan. 1, 2015

(54) Anticounterfeiting labeling system for products in general and for the download of multimedia products

(71) Applicants: Giorgio Romi, Asciano (SI) (IT); Andrea Tommasi, Asciano (SI) (IT)

(72) Inventors: Giorgio Romi, Asciano (SI) (IT); Andrea Tommasi, Asciano (SI) (IT)

(21) Appl. No.: 14/372,086

(22) PCT Filed: Jan. 18, 2013
(86) PCT No.: PCT/IB2013/050472

§ 371 Date: Jul. 14, 2014

(30) Foreign Application Priority Data
Jan. 20, 2012 (IT) PI2012A000008
Nov. 16, 2012 (IT) FI2012A000247

(51) Int. Cl. H04L 29/06; G06K 19/06; G09F 3/00; G06F 17/30

(52) U.S. Cl. CPC H04L 63/08; G06F 17/30879; G06K 19/06037; G09F 3/0292; G09F 2003/0213
USPC 726/5; 235/375

(57) ABSTRACT

A labeling system includes a label applicable on a product and provided with an identification code of the product, the identification code being covered with a non-transparent covering varnish or ink of the removable type; a server; wherein the identification code is a QR-code bi-dimensional bar code which is read through an external electronic device in such that, following the reading, the external electronic device makes an Internet connection to the server.

### TECHNICAL FIELD

The present invention refers to the technical field relative to the labeling of food and non-food products.

In particular, the present invention refers to an innovative system that provides for the absolute authenticity of the product in question, preventing counterfeiting and fraudulent duplications and, contextually, for the possibility of downloading information via the Internet concerning the product.

### BACKGROUND ART

The labeling of products, on which there is a mark that guarantees the originality of the product purchased, either a food product or a product of another kind, has long been known.

A frequent use of this type of labeling concerns, for example, wine bottle on which the label indicates a recognition mark that guarantees the authenticity of the product.

As it is well known a trademark, and therefore the product that it identifies, can be easily counterfeited, thus bringing to the market products that are not original, that are of poor quality and that often present health risks.

The counterfeited products can be any type of products, from food products to multimedia ones.

In the course of time various solutions have been proposed in order to verify the authenticity of a product for sale.

One of these solutions is, for example, described in patent application publication US2004/034579, which describes a method for preventing counterfeiting. The method provides for the realization of a code in the form of a bar code to be applied to each product. The code has a first part that indicates the production date and a second part that identifies the product. The code is covered with a covering varnish of the removable type and is memorized on an Internet site. Following the connection to the site and the loading of the code, the existence of the code can be verified. Once it has been searched it can be cancelled from the archive.

Nevertheless, the use of an ordinary bar code does not allow the memorization and the consultation of information relative to the product but just the fact that this code is existing or not. Moreover, in accordance with this method, the user has to connect every time to the site and insert manually the code. This operation certainly does not result to be easy and practical.

The bar code, besides, is limited in the possible combinations, therefore there is the risk that the combinations that can be used for a high number of products are over quickly.

### DISCLOSURE OF THE INVENTION

It is therefore the aim of the present invention to provide a labeling system for products in general that solves at least in part said technical drawbacks.

In particular, it is the aim of the present invention to provide a labeling system that totally prevents the fraudulent reproduction and any efforts to introduce fraud on the label itself, guaranteeing the originality and quality of the product on which it is displayed.

It is also the aim of the present invention to provide a system and relative method of labeling that results simple in use and allows not just the verification of the originality of the product but that also lends itself well to other operations such tracking electronically additional information and downloading multimedia contents.

These and other advantages are obtained with the present labeling system as described hereinafter.

Such a labeling system comprises:

A label (1) applicable on a product (100′), for example a bottle (100′), and provided with an identification code (5) of the product (100′), said identification code being covered with a non-transparent covering varnish or ink (2) of the removable type; and

A server (15).

In accordance with the invention, the identification code (5) is a bi-dimensional QR-code bar code which is read through an external electronic device (10) in such a way that, following said reading, the external electronic device makes an Internet connection to said server (15).

In this way, the connection to the server, once the varnish has been removed and the code has been read, allows a verification of the authenticity of the product.

The reading of the QR Code allows having an automatic connection and tracking at any time, comfortably on one' s own palmtop, all the information requested, including the verification of authenticity.

The use of the QR Code also allows downloading much more information apart from that related to the verification of authenticity. For example, additional multimedia information can be downloaded.

Advantageously, the server (15) is configured in such a way that, in correspondence of the reception of the same identification code (5) for a number of times at least equal or superior to two, it elaborates in return a corresponding notice message.

Advantageously, the server (15) may include an internal archive (20) for containing all the identification codes (5) of products launched to the market.

Advantageously, the server (15) may include a counter associated with each single identification code memorized in the archive (20), the counter increasing in number by one in correspondence of each access request to the server through the connection to the server obtained with the specific identification code.

Advantageously, the server (15) verifies the uniqueness of the identification code, cancelling from its memory the identification code once the access request to the server through the specific identification code has been received.

It is also here described a labeling method for verifying the authenticity of a product (100′) and comprising the steps of:

Performing the labelling of the product through the application of a label (1) provided with an identification code (5) associated with the product (100), the identification code (5) being darkened by a covering material or ink of the removable type, the identification code being a bi-dimensional QR Code;

Removal of the covering material or ink;

Reading of the underlying identification code through an external electronic device (10) in such a way that, following said reading, the external electronic device makes an Internet connection to an external server (15).

Advantageously, following the connection to the server (15), a further operation of verification may be performed in which the server checks the number of times in which an access to the server has been requested with the same identification code.

Advantageously, the server (15) may send to the external electronic device (10) a notice message at least in the situation in which the same code has already been read before.

Advantageously, the server implements said operation of verification in one of the following two ways:

Memorization in an archive (20) of all the presented codes;

Association of an incremental counter for each code;

Increase of one for each access request corresponding to a pre-determined code;

Verification of the increase obtained and selection of a corresponding reply message to be sent to the external electronic device (10);

Or, alternatively:

Memorization in an archive (20) of all the presented codes;

In correspondence with an access with a predetermined code, cancellation from the archive of said identification code.

In this case, in case of a second access, since the code will not be found, the return message will be that of non-authenticity of the product.

The above described method therefore allows not only the verification of authenticity of a product but also the downloading of additional information.

It is also described herein a method for downloading information which can comprise, as said above, the verification of authenticity of the product in electronic format or other multimedia information and comprise the steps of:

Generation of one or more QR codes (130), each QR code being associated with one or more pieces of information in electronic format, the QR Code being further covered with a covering element (120) of the removable type to darken the underlying QR code;

Application of the QR on a specific cardboard sheet (100) that can be sold separately or associated to a generic product to be sold;

Wherein the operation of acquisition of the information associated with the QR Code through the removal of the covering element, the acquisition of the image of the QR code through an external device (10) and the subsequent connection of said external device to a dedicated server (150) via the Internet are provided, the server sending directly to said external device (10) the electronic information associated with said QR Code.

In this way the user, by purchasing separately the cardboard sheet or purchasing a cardboard sheet associated with a product, can download various pieces of information associated with the product, for example a verification of originality.

The same system lends itself well for other uses.

Instead of purchasing physically a CD a cardboard sheet can be purchased, which allows downloading the CD directly to the PC or any other suitable device. Likewise, if the cardboard sheet is associated with a book, it is possible to substitute the inserts associated with the book with electronic archives that can be easily downloaded.

Advantageously, said electronic information associated with the QR Code can provide for one or more of the following options:

Music files;

Books, magazines, newspapers and similar products;

Video files;

APPS or computer programs.

Advantageously, the information relative to said QR code allows the access via the Internet to a web page menu that permits the complete multimedia illustration of a touristic itinerary.

Advantageously, said menu provides for access to various points of a pre-established artistic itinerary, for example a visit to a museum.

Advantageously, the covering element (120) is in the form of a varnish, for example silvered or golden, which can be scratched away.

Advantageously, the covering element is in the form of a removable adhesive sheet that cannot be re-positioned.

It is also described herein a method for downloading information in electronic format, such as the verification of authenticity of a product, comprising the steps of:

Generation of one or more QR codes (130), each QR code being associated with one or more pieces of information in electronic format, the QR Code being further covered with a covering element (120) of the removable type in such a way as to darken the underlying QR code;

Application of the QR code directly on a generic product to be sold;

Wherein the operation of acquisition of the information associated with the QR Code through the removal of the covering element, the acquisition of the image of the QR code through an external device (10) and the subsequent connection of said external device to a dedicated server (150) via the Internet are foreseen, the server sending directly to said external device (10) the electronic information associated with said QR Code.

Advantageously, said QR Code allows downloading supplemental electronic information relative to the generic product on which it has been applied.

Advantageously, said electronic information can foresee one or more of the following options:

Music files;

Books, magazines, newspapers and similar products;

Video files;

Codes for participating in contests with prizes.

### BRIEF DESCRIPTION OF DRAWINGS

Further features and advantages of the present system, according to the invention, will result clearer with the description that follows of some preferred embodiments, made to illustrate but not to limit, with reference to the annexed drawings, wherein:

FIG. 1 describes a label for products in general, for example bottle wines, provided with a covering varnish or ink that is removable that covers and darkens an underlying bar code (QR Code);

FIG. 2 shows in a non limiting manner the label applied to a bottle wine or another similar alcoholic product;

FIG. 3 shows the partial removal of the ink that covers the underlying identification code 5;

FIG. 4 shows the code brought to light;

FIG. 5 shows schematically an Internet connection to a server through an electronic device 10 capable of acquiring the image of said code and of elaborating it for making said connection;

FIG. 6 shows an example of archive for containing codes emitted and placed in the market;

FIG. 7 shows schematically, with a flowchart, the operating principle of an embodiment of the invention;

FIG. 8 and FIG. 9 show the application of the QR code to a cardboard sheet separated and connected to a multimedia content;

FIG. 10 shows the image acquisition with the smartphone and FIG. 11 shows the access to the data contained in the database 500 of the server.

### DESCRIPTION OF SOME PREFERRED EMBODIMENTS

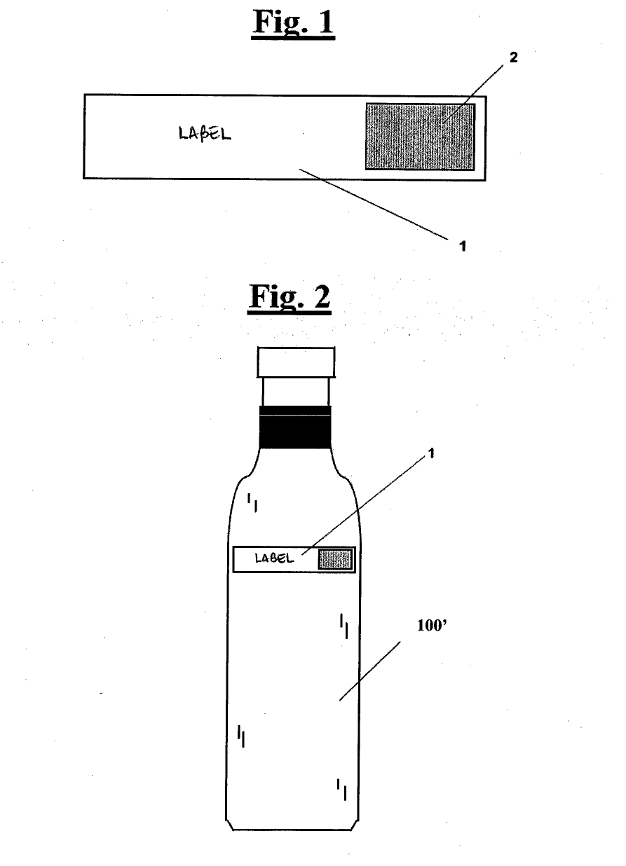

FIG. 1 therefore describes a label in accordance with the present invention. The label, as shown in FIG. 4, presents an identification code 5 which is such as to be read electronically by an external electronic device 10 capable of making an Internet connection, for example a palmtop or a mobile phone provided with photocamera of the smartphone type.

As shown in FIG. 4, the identification code 5 is a bi-dimensional bar code (QR Code).

Bi-dimensional bar codes present themselves in a quadrangular form and are suitable for being framed with devices such as ordinary palmtops or smartphones, now of common use. Each code is different from the others since its bi-dimensional combination allows an infinite number of combinations, all different from each other. It is enough to install in one's own palmtop a specific free application that permits the acquisition of the image and its subsequent translation, obtaining an Internet connection to a specific server. The server will open a specific page visible on the palmtop and that, in the case in question, will display one or more data of the product purchased and additional supplementary information.

In this way, the user will have the certainty that the product purchased, on the basis of its “on line” label, is original.

This type of code, once purchased from the external electronic device 10, allows the device to connect to a server 15 via the Internet, therefore having access to one or more specific pages whose address is precisely codified by said QR Code.

In this way, the reading and the connection to the web page take place automatically.

FIG. 5 shows schematically, just as a way of example, the acquisition of the code through a palmtop 10 and the subsequent protected connection to a server 15 that allows the opening of one or more Internet pages, corresponding to the address cryptographed by the code, directly on the palmtop.

In accordance with a first aspect of the invention, therefore, as shown in FIG. 1, the label is covered with a covering material 2 of the removable type, that is a transparent varnish or an ink (golden, silvered or of another color), which prevents a visualization of the underlying code and which can be progressively scratched or taken away, making the underlying code come to light.

The use of a covering varnish (or ink) that can be taken away is essential since it exceeds the limit of a covering of the code obtained in a simpler way with a non transparent adhesive label, which however could be easily re-positioned once the underlying code has been removed and read.

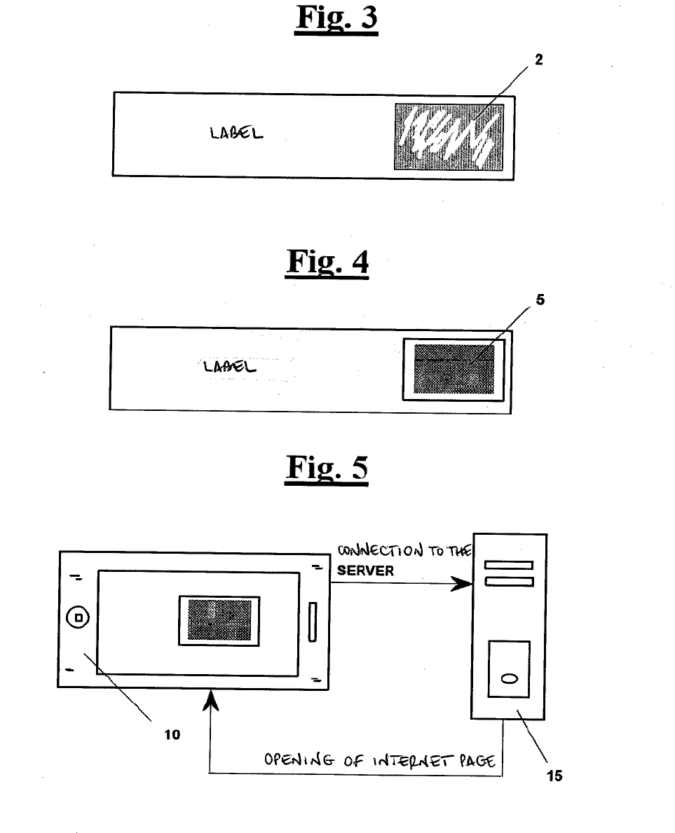

As shown in FIG. 3 and in subsequent FIG. 4, it is necessary to scratch away the covering varnish (exactly as it is made with a scratchcard) to bring to light the underlying code 5.

This simple solution is advantageous since it permits an immediate visual indication of the fact that a pre-determined label has already been used or not.

In particular, if a counterfeiter tried to apply, on a product, fake products labels that have already been used, his try would fail because the code is not covered by the varnish anymore and therefore that clearly indicates a previous use of said label.

Nevertheless, the covering varnish could be re-applied or the code could be copied and then on the reproduced code a covering varnish could be applied. In a few words, it would not be impossible to integrally produce counterfeit labels identical to the original ones to be applied to products that are clearly counterfeit.

To that aim, the use of an identification code of the QR type (QR code), therefore capable of allowing a connection to a web page following the acquisition of its image, is essential for the following reasons:

Currently, also in the event of a counterfeit label displaying an intact covering varnish, the user does not have a way of understanding the fraud since the connection to the server will provide the opening of a specific web page of the producer of the product in question and that confirms the fact that the code corresponds to an original product. Nevertheless, as said, the code could be copied and applied to a counterfeit product.

In order to solve said technical problem, the server 15 may include an archive 20 containing in memory all the identification codes produced and launched to the market. These can, for example, be furnished directly by the producer and on indication of the producer linked specifically to the product to certify and therefore applied each one to one of the products launched to the market. Each new code realized in the form of a label is therefore memorized in the archive, which is constantly updated.

The bi-dimensional codes lend themselves very well to their “random” production, being practically infinite the possibilities of generating alphanumeric codes, always different one from each other. Each code will therefore be different from all the others that have already been generated.

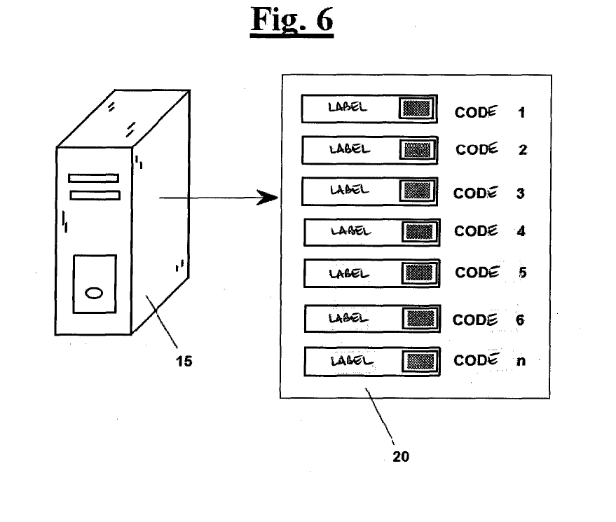

FIG. 6 schematizes the archive 20 of the server on which said identification codes are loaded.

In this way, when the Internet connection to said server 15 takes place, following the purchase of the image of the QR Code the server is capable of verifying in its archive the presence of the corresponding code among all the n codes memorized.

The server is therefore programmed in such a way as to give in return to the user the additional information if said specific code has been inserted and if it has been already read previously or not. In the case it did not exist or it had not already been read before, this implies that the code inserted has been copied or counterfeited with precision. Instead, if there does not appear any notice message of this type it means that the code is original and virgin in the use.

The methods with which said functionalities can be implemented are different.

For example, in a first embodiment of the invention, for each code the following can be provided: a counter eventually integrated to a date and time field. The counter increases of 1 every time the connection to the server takes place with the same code (code counter=code counter+1) and the date and time field is now filled in at the moment of the first consultation.

If a user, therefore, makes an access for a second or subsequent time with the same code, this increases every time of 1. A specific controller foresees the sending of an “attention” message containing date and time of the first consultation when the counter reaches the value of 2 or numbers higher than 2.

In another variant of the invention, the code may simply be cancelled from the archive once it has been read a first time. In this way, at the moment of a subsequent connection to the server with the same code, the server, not finding the code in its archive, will send an equivalent attention message.

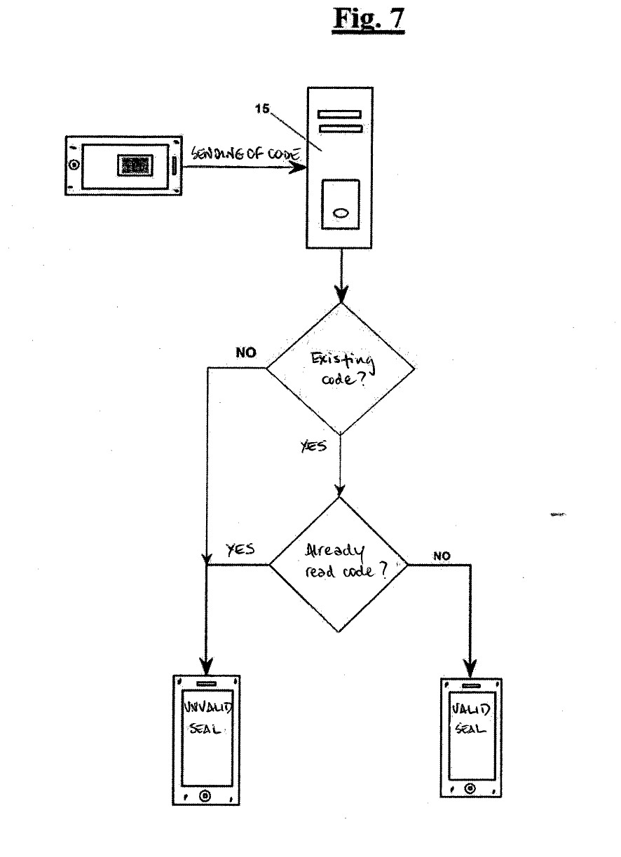

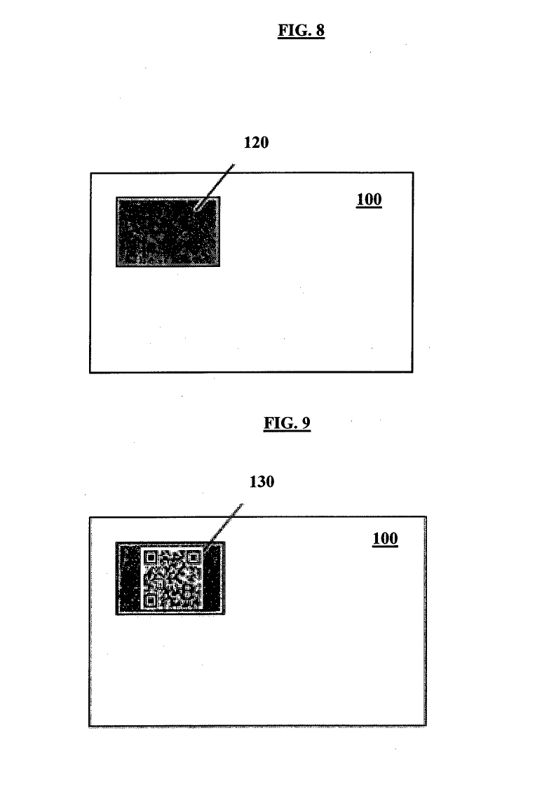

FIG. 7 shows how said functionality is implemented independently from the modality with which the server is capable of verifying that the code has actually been read.

In particular, FIG. 7 shows how, following the reception of the code and once the uniqueness of the reading of it has been verified according to the possible solutions that have been described above, the server 15 sends by return a validity message (or not) of said code.

The message can contain one or more identification pieces of information of the product, such as the mark, or the type. Such information is useful to guarantee the verification of the originality of the product.

The present invention is addressed to the labeling of any product that can be commercialized and therefore is not limited to the labeling of wines or alcoholic and nonalcoholic products in general.

In fact, the system described herein allows also the downloading of generic information on the product and therefore a verification of its originality through the reading of the code itself

The same invention can therefore be used to guarantee the “download” of other authentic information, inhibiting piracy and fakes.

Indeed, in the current state of the art, the diffusion of products of informative nature is made through the physical realization of the product itself and its launch to the market. For example, a book, a music CD or additional inserts of printed texts, for example a DVD combined with a book. These are just some examples of selling and launching to market of such products.

A video or a multimedia support can however be counterfeited, damaging the producer.

An insert attached to a magazine in multimedia format (for example an attached CD) requires the realization of the CD with the risk that it is stolen, and therefore cause additional costs.

The same traditional realization of a book or magazine implies the use of paper and therefore has a significant impact on the environment and the economy.

It is therefore clear that there is the need to have an alternative method that allows launching to market this type of information so that it is safe from piracy, in a quick way, and that allows solving at least in part said technical drawbacks.

FIG. 8 shows a cardboard sheet 100 as described before. The cardboard sheet 100, as shown in FIG. 8, presents a part 120 which is covered with the covering layer of the removable type, for example a silvered varnish as used for the ordinary “scratchcard” which can easily be scratched away, as previously described.

Obviously, equivalent covering solutions can be used, for example an adhesive tape of the removable type.

In all these cases, as shown in subsequent FIG. 9, the removal of the covering layer brings to light the bi-dimensional code of the “QR Code” type 130.

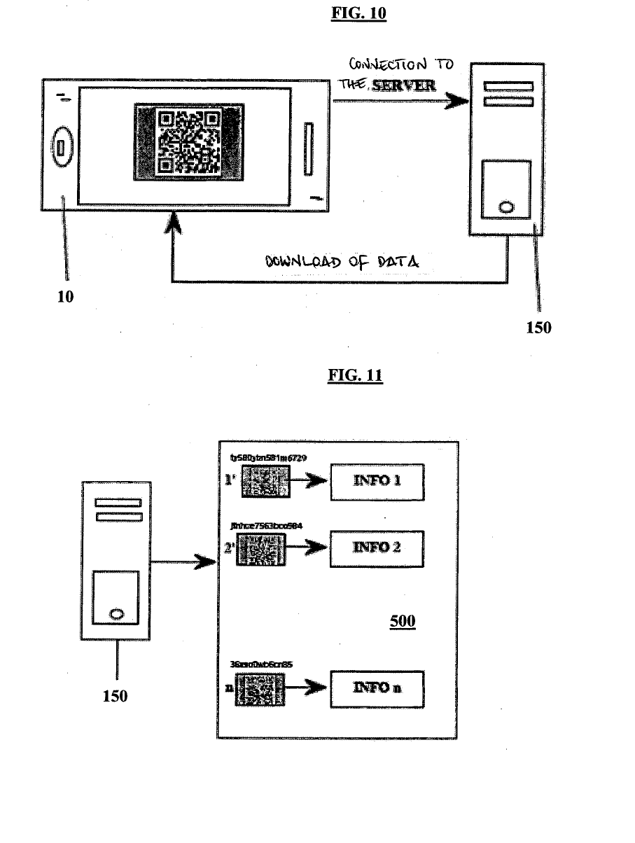

The underlying QR code is always connected to a specific server 150 that contains inside it a database 500, as shown in FIGS. 10 and 11.

The use of a covering of the QR code is essential since it guarantees not just the originality of the code but also, and above all, that such a code has not been previously used in a fraudulent manner by a previous user.

In that case, the use of covering varnishes, such as those of the “scratchcard”, is preferred.

The QR code is therefore acquired by a common device suitable for making such an operation, for example a smartphone, which, thanks to the application integrated in it, connects to the server that, having previously verified the validity of the code, permits the downloading of the multimedia contents associated with this QR Code to the relative smartphone, or other devices as described above.

FIG. 11 shows schematically all the data associated with each QR Code (Info 1′ associated to the QR code 1′, info 2′ associated to the QR Code 2′ and info n associated to the nth QR code).

As a consequence, each QR code framed by the smartphone determines the download of the specific associated contents.

The server 150 may be programmed to cancel from its internal memory an eventual QR code that has already been used. This will not make the database 500 heavier with data that is already useless and will avoid possible unauthorized subsequent downloads.

The present invention has therefore innumerable applications, among which, just as a way of example but not limiting, three are described below:

Purchase of a book provided with multimedia contents:

In this case the book presents on a separate cardboard. sheet, or integrated in a page of the book itself, a covering varnish whose removal brings to light the QR Code. The purchase and the processing of the QR Code with traditional devices, for example a tablet, allows a download of the multimedia contents via the Internet in electronic format directly to the device used (the tablet in this example) and associated with the QR Code in question. In this way, there is access to these inserts, solving various technical problems, among which the first one is that it is not necessary anymore to have to produce them separately physically and to attach them to the book. This implies reduced costs and saving of material.

Purchase of a book, newspaper or magazine in general in electronic format:

In this case it is possible to purchase directly the cardboard sheet corresponding to the book or other product and to scratch away the covering varnish. The cardboard sheet highlights the QR Code which, as described above, now allows a download of the content associated with it, that is an entire book, newspaper or magazine. The same is perfectly possible for the selling of music CDs or electronic archives in general (for example electronic games).

Purchase of a tourist audio guide or for specific exhibitions:

A further example of use concerns instead the interactive purchase of a guide, for example one relative to the visit to a museum.

The purchase of the cardboard sheet allows taking advantage of the information relative to the cognitive itinerary that wants to be followed in such a way that the user, through his own mobile phone, can comfortably read and listen to all the explanations relative to the selected itinerary.

Having said this, it is obvious that the purchase of a touristic itinerary lends itself well to different variants.

For example, the information contents to which there is access can be individuated through a web page menu in which each work of art associated with the pre-established itinerary can be illustrated on the basis of an itinerary made available by the visitor. In this way, the user has all the time that he wants to stay in front of the work of art, about which he is listening to an explanation, without. being bound to modes and times of visit imposed by the sequence of the registration of a compulsory itinerary. A lot of other information can be downloaded, such as computer applications (APPS), for PCs, Tablets or Smartphones.

Alternatively, the cardboard sheet can include numerous QR codes and each QR code is associated with a work of art of the pre-established itinerary.

The invention claimed is:

1. A labeling system comprising:
a label (1) applicable on a product (100′) and provided with an identification code (5) of the product (100′), said identification code being covered with a removable non-transparent covering varnish or ink (2); and
a server (15);
wherein the identification code (5) is a QR-code bi-dimensional bar code which is configured to be read through an external electronic device (10) such that, following said reading, the external electronic device makes an Internet connection with said server (15).

2. The system, as per claim 1, wherein the server (15) is configured in such a way that, upon reception of the same identification code (5) for a number of times at least equal or superior to two, the server elaborates in return a corresponding notice message.

3. The system, as per claim 1, wherein the server (15) comprises an internal archive (20) for containing all the identification codes (5) for labels produced and launched to market.

4. The system, as per claim 3, wherein the server (15) comprises a counter associated with each single identification code memorized in the archive (20), the counter increasing in number by one in correspondence of each access request to the server through a connection to the server obtained with a specific identification code.

5. The system, as claim 1, wherein the server (15) verifies a uniqueness of the identification code, cancelling from its memory the identification code once an access request to the server through a specific identification code has been received.

6. A labeling method for verifying authenticity of a product (100′), the method comprising the steps of:
labeling the product through application of a label (1) provided with an identification code (5) associated with the product (100), the identification code (5) being hidden by a covering and removable material or ink, the identification code being further configured to be readable by an external electronic device (10) so that, after reading, the external electronic device makes an Internet connection to an external server (15);
removing the covering material or ink;
reading the underlying identification code with the external electronic device (10); and
connecting to the server (15).

7. The labeling method, as per claim 6, wherein after the step of connecting to the server (15), a further step of verifying is included, by which the server checks a number of times when an access to the server with the same identification code has been requested.

8. The labeling method, as per claim 6, further comprising the step of sending from the server (15) to the external electronic device (10) a notice message at least when the same identification code has already been read before.

9. The labeling method, as per claim 7, wherein the server performs the step of verifying by:
memorizing in an archive (20) of all the stored codes;
associating an incremental counter for each code;
increasing by one for each access request corresponding to a pre-determined code; and
verifying an increase obtained and selection of a corresponding reply message to be sent to the external electronic device (10).

10. A method for downloading information in electronic format comprising the steps of:
generating one or more QR codes (130), each QR code being associated with one or more pieces of information in electronic format, the QR Code being further covered with a removable covering element (120) to darken an underlying QR code;
imprinting the QR code on a cardboard sheet (100) to be sold separately or associated with a product to be sold; and
acquiring the information associated with the QR Code by removing the covering element, an image of the QR code being acquired through an external device (10) and a subsequent connection of said external device to a dedicated server (150) via the Internet, the server sending directly on said external device (10) electronic information associated with said QR Code.

11. The method, as per claim 10, wherein said information associated with the QR Code is:
music files;
books, magazines, newspapers or publications; or
video files.

12. The method, as per claim 10, wherein the acquiring the information associated with said QR code provides access via the Internet to a first menu web page in which a touristic itinerary is displayed.

13. The method, as per claim 12, wherein said first menu includes access to various points of a pre-established artistic itinerary.

14. The method, as per claim 10, wherein the covering element (120) is a varnish configured to be scratched away.

15. The method, as per claim 10, wherein the covering element is a removable adhesive sheet.

16. A method for downloading information in electronic format comprising the steps of:
generating one or more QR codes (130), each QR code being associated with one or more pieces of information in electronic format, the QR Code being further covered with a removable covering element (120) to darken an underlying QR code;
imprinting the QR on a specific cardboard sheet (100) to be sold separately or associated to a product to be sold;
removing the covering element;
acquiring an image of the QR code through an external device (10); and
connecting said external device to a dedicated server (150) via the Internet, the server sending directly on said external device (10) electronic information associated with said QR Code.

17. The method, as per claim 16, wherein said QR Code enables a download of supplemental electronic information relative to the product on which the QR code has been applied.

18. The method, as per claim 16, wherein said electronic information is:
music files;
books, magazines, newspapers, or publications;
video files; or
APPS or computer programs.

19. The method, as per claim 7, wherein the server performs the step of verifying by:
memorizing in an archive (20) of all the stored codes; and
upon access with a predetermined code, canceling from the archive said identification code.
